(19) United States
(12) Patent Application Publication
(10) Pub. No.: US 2019/0072736 A1
(43) Pub. Date: Mar. 7, 2019

(54) HIGH DENSITY DISTRIBUTION FRAME WITH AN INTEGRATED SPLICING COMPARTMENT

(71) Applicant: CORNING RESEARCH & DEVELOPMENT CORPORATION, Corning, NY (US)

(72) Inventors: Frank J. Glatzl, St Paul, MN (US); Daniel Henderson, Corning, NY (US); Rutesh D. Parikh, Corning, NY (US); Jerome Allen Pratt, Round Rock, TX (US)

(73) Assignee: CORNING RESEARCH & DEVELOPMENT CORPORATION, Corning, NY (US)

(21) Appl. No.: 16/085,092

(22) PCT Filed: Feb. 9, 2017
(86) PCT No.: PCT/IB2017/050705

§ 371 Date: Sep. 14, 2018

Related U.S. Application Data
(60) Provisional application No. 62/308,534, filed on Mar. 15, 2016.

(51) Int. Cl. G02B 6/44

(52) U.S. Cl. CPC G02B 6/4455; G02B 6/4477; G02B 6/4471; G02B 6/4452

(57) ABSTRACT

The present invention is directed a high density optical fiber distribution system having a preterminated optical fiber termination block assemblies and an integrated splicing compartment disposed on a frame. The preterminated optical fiber termination block assembly includes optical fiber termination block with an installed multi-fiber stub cable. Each optical termination block has a plurality of termination modules has a plurality of connector adapters into which optical fiber connectors disposed on a first end of the multi-fiber stub cable are connected. A second end of the multi-fiber stub cable is connected to a distribution cable in the integrated splicing compartment, wherein the splicing compartment comprises a plurality of drawers containing optical splices and wherein each drawer of the splicing compartment can be correlated to the preterminated optical fiber termination block assembly.

### FIELD OF THE INVENTION

The present invention generally relates to connection systems for telecommunication cables, and more particularly to a high density optical fiber distribution system used to cross-connect and interconnect optical fibers used in telecommunications, the system providing an on-frame splicing compartment with dedicated splice storage for a preterminated optical fiber termination block assembly.

### BACKGROUND

In the field of telecommunications, conventional copper wires are being replaced by optical fiber transmission lines. Thus, it is necessary to provide a distribution and organizing facility for the fiber-optic cables at appropriate locations within exchanges inside telecommunication companies, office buildings or cabinets in the outside plant.

Typical distribution systems or optical distribution frames are used in the central office of telecommunication companies as manual patch panels for connecting outside plant optical cables with central office equipment. Conventional optical distribution frames are typically large and/or specialized frame structures to provide access points for the optical network to allow the inter connection to optical equipment, other optical network equipment and/or to customer lines. The connections are made in optical fiber termination blocks, which are structures containing optical connection modules and optical devices.

The optical connection modules connect optical fibers of a main cable (the so-called network cable) and/or of distribution cables (station cables) to cables running to the customer or to an optical device. Alternatively, the optical connection modules can be used for interconnecting optical fibers of two or more distribution cables. Often, the optical termination modules also contain storage space for spare length of optical fiber to facilitate removal/replacement of bad or underperforming connections with new, more stable connections. Optical devices, on the other hand, perform functions within the network such as splitting (passive optical device) or amplification (active optical device). The optical connection modules generally comprise a housing, a cassette supported by the housing for stowing optical fibers, optical fiber splices, and/or optical devices, and an optical connector patch panel.

Installation of this type of terminal block can be a complex process requiring splices to be made in each optical connection module in the termination block.

As telecommunication companies migrate from copper networks to optical fiber networks, they need to accommodate the infrastructure for both the existing copper network and the incoming newer fiber network. However, space within the central offices is usually limited. Thus, what is needed is an easy to install high density fiber distribution system that is both modular and expandable to allow for staged installation of the system and that can be accommodated on existing rack and frame structures rather than requiring the specialized frame systems.

### SUMMARY

The present invention is a high density optical fiber distribution system having preterminated optical fiber termination block. In particular, the exemplary fiber distribution frame includes a rack, a preterminated optical fiber termination block assembly mounted to the frame, wherein the preterminated optical fiber termination block assembly includes a plurality of termination modules configured to connect optical fiber connectors disposed on a first end of a multi-fiber stub cable with adapter mounted in a face of each termination module, and a splicing compartment mounted on the rack configured to interconnect a second end of the multi-fiber stub cable to a distribution cable, wherein the splicing compartment comprises a plurality of drawers containing optical splices and wherein each drawer of the splicing compartment can be correlated to one of the preterminated optical fiber termination block assembly. In one aspect, there is a one-to-one correlation between one of the plurality of drawers in the splicing compartment and the preterminated optical fiber termination block assembly mounted to the frame.

### BRIEF DESCRIPTION OF THE DRAWINGS

The present invention will be further described with reference to the accompanying drawings wherein like reference numerals refer to like parts in the several views, and wherein:

FIG. 1A is a schematic isometric view of an exemplary high density fiber distribution frame with integrated splice chamber according to an embodiment of the present invention.

FIG. 1B is a back view of an exemplary high density fiber distribution frame with integrated splice chamber according to an embodiment of the present invention.

FIG. 1C is a block diagram showing the exemplary high density fiber distribution frame of FIGS. 1A and 1B.

FIG. 2 is a schematic diagram of an exemplary stub cable that can be used in an optical fiber termination block of the high density fiber distribution frame according to an embodiment of the present invention.

FIGS. 3A-3D are four views of an exemplary splice chamber according to an embodiment of the present invention.

FIG. 4 shows details of the interior of a drawer of the splice chamber of FIGS. 3A-3D.

FIGS. 5A and 5B are two views of an optical fiber termination block according to an embodiment of the present invention.

FIGS. 6A and 6B are two views of a patch cord management device according to an embodiment of the present invention.

While the invention is amenable to various modifications and alternative forms, and specifics thereof have been shown by way of the drawings and will be described herein in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The present invention is directed to a high density fiber distribution system which utilizes a standard telecommunication rack commonly used in the industry today. The exemplary high density fiber distribution system, described herein, is modular and provides a higher density of connections than is currently available. In particular, system comprises the preterminated optical fiber termination blocks having a plurality of termination modules configured to connect optical fiber connectors disposed on a first end of a multi-fiber stub cable with adapter mounted in a face of each termination module and an on frame splicing compartment with dedicated splice storage for the preterminated optical fiber termination block.

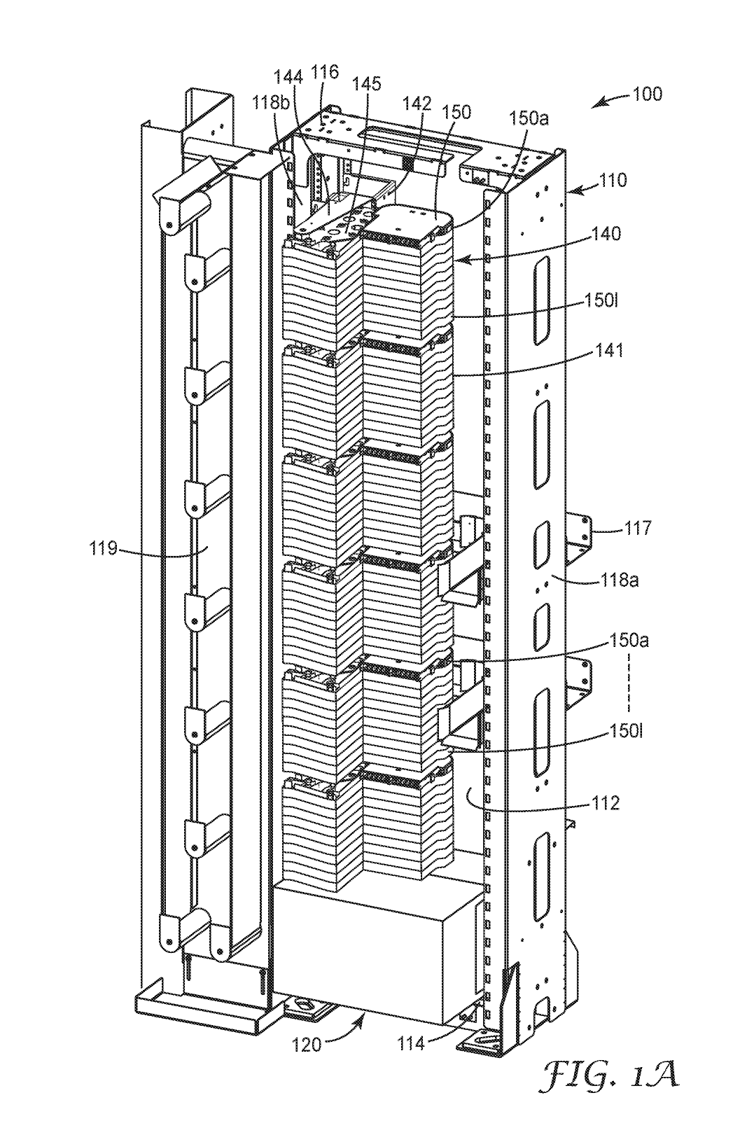

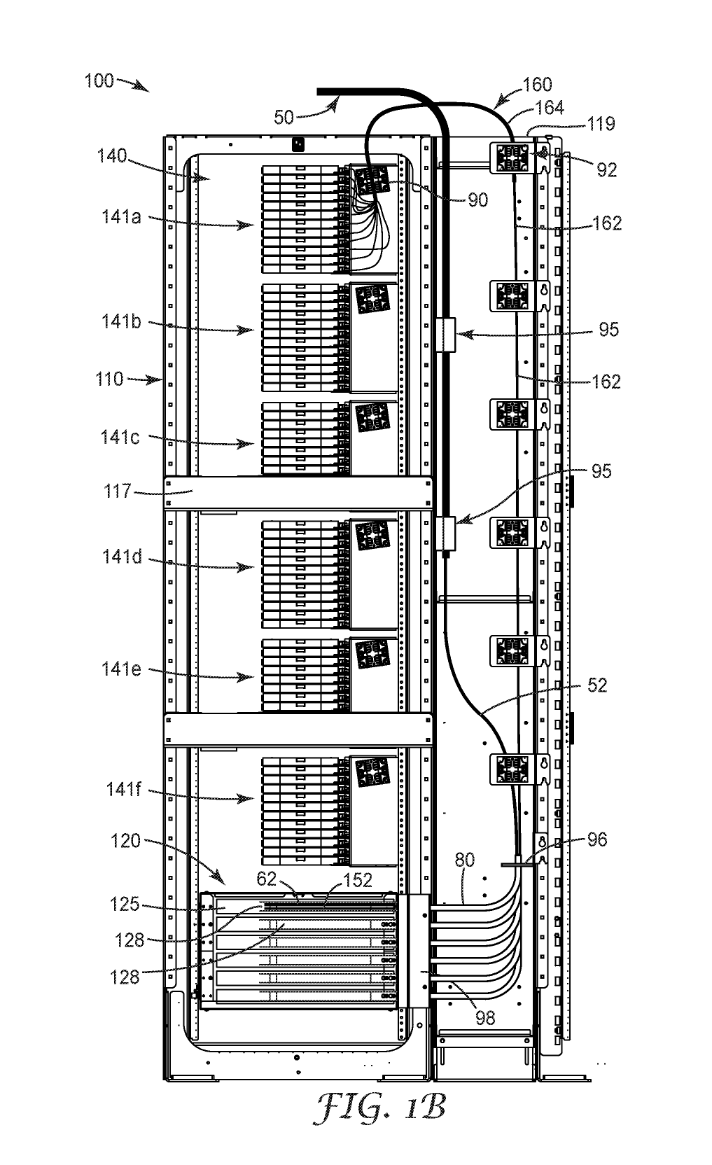

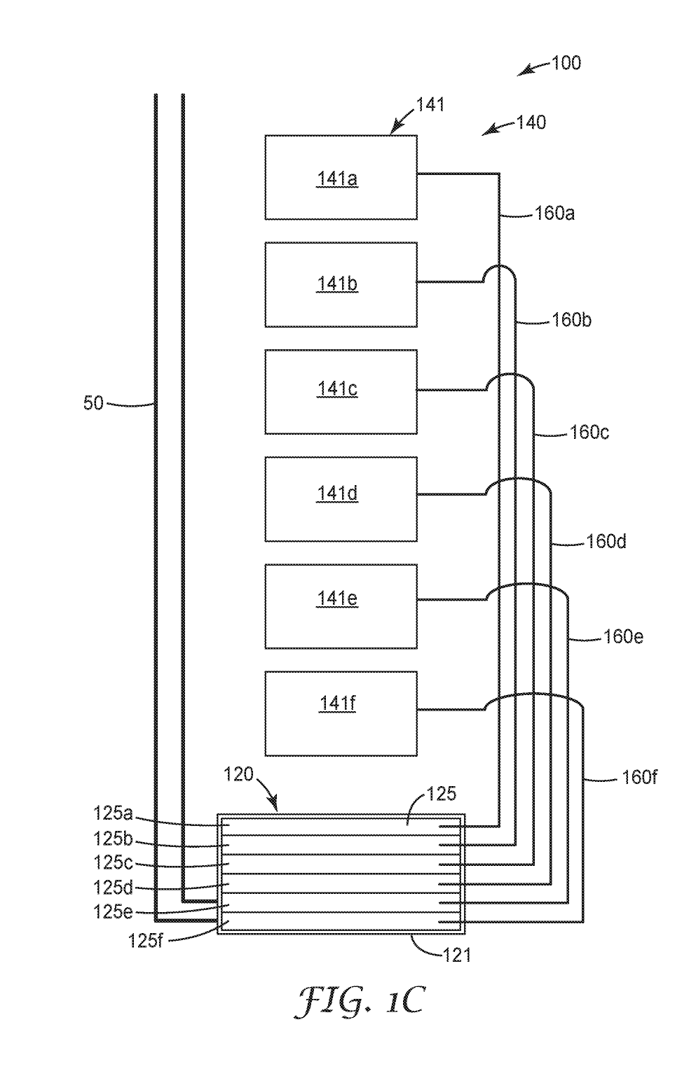

FIGS. 1A-1C shows an exemplary embodiment of a high density fiber optic distribution system 100 of the present invention. Distribution system 100 includes frame 110 having a single bay 112 disposed between the base 114 and top cross member 116 of the rack and between the vertical support members 118a, 118b. An integrated splicing compartment 120 and several preterminated optical fiber termination block assemblies 140 can be attached to the frame in a vertical stack. In one aspect, frame 110 can be a conventional open two post Electronic Industries Association (EIA) 19 or 23 inch equipment rack which is commonly used in the telecommunications industry. These racks can have a bay that is approximately 7 ft. high and 23 in. wide. While exemplary high density fiber optic distribution system is described in reference to a 23 inch equipment rack, this should not be interpreted as a limitation of the current disclosure. It is anticipated that the exemplary distribution system could be used in conjunction with other frame structures used in the telecommunication system including a standard 19 inch equipment rack, European standard racks, or other standard racks used around the world. The exemplary fiber distribution system can further include a jumper cable/patch cord routing and slack storage area 119 in the form of a jumper spool bay attached to one of the vertical support members 118a, 118b to support jumper slack management. Spools in the jumper spool bay are designed to maintain the bend radius of the jumper cables. On the backside of the jumper spool bay, the system can include simplified integrated cable management for the distribution and stub cables on the frame separated from the location where the jumper cables are managed.

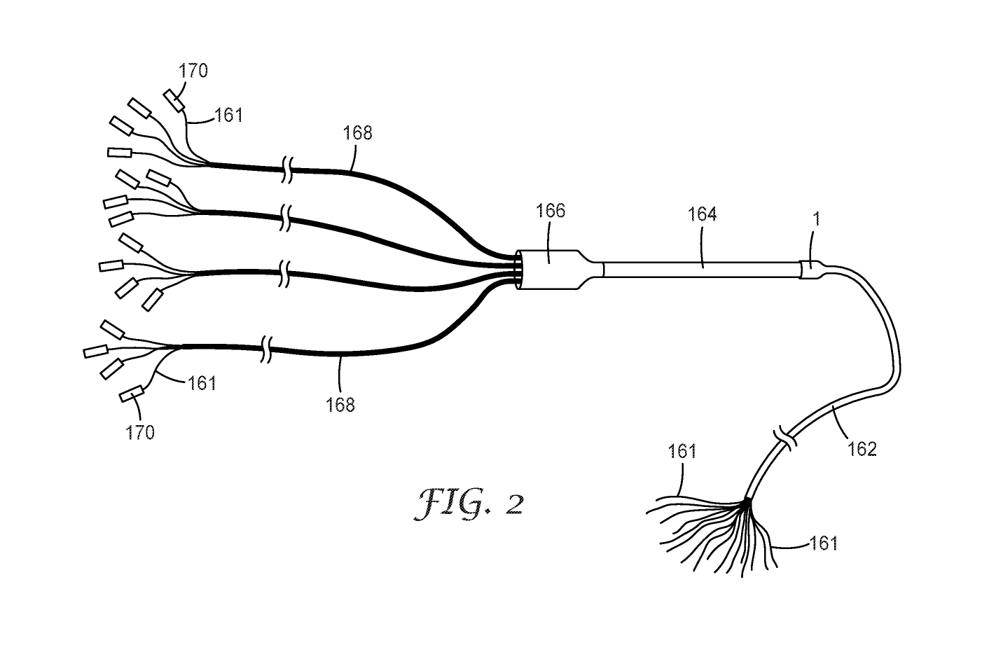

The preterminated optical fiber termination block assembly 140 is an optical fiber termination block 141 that has been preterminated with a stub cable 160. FIG. 2 shows a schematic representation of an exemplary stub cable 160 that can be used in an optical fiber termination block.

Stub cable 160 can be prepared from a high fiber count cable section. In one aspect, a section of indoor riser rated 144 fiber cable containing twelve 12 fiber ribbons in a loose tube can be used to make the stub cable, such a Ribbon Fiber Cable, Riser, 144 F, Single-mode (OS2), available from Corning, Inc. (Hickory, N.C.). In another aspect, a section of indoor riser rated 144 fiber cable containing twelve loose buffer tubes, each containing twelve 250 or 900 micron optical fibers tube, can be used to make the stub cable, such as ezDISTRIBUTION™ Indoor Tight Buffered Riser, 144 color-coded 900 μm tight buffered fibers into a single flame retardant cable, available from Prysmian Group (Lexington S.C.). Other high count optical fibers can be used to prepare stub cable 160. These high fiber count cables are generally stiff. The protection of the jacked cable can be utilized in areas where the fibers could be subject to damage from external forces and where there is sufficient space to accommodate the cable bend radius. However a more flexible stub cable is generally desired when considering slack storage and accessing the optical fiber termination block and the integrated splicing compartment.

Exemplary stub cable 160 includes a plurality of optical fibers 161 having optical fiber connectors 170 mounted on one end thereof. In an exemplary aspect, the optical fiber connectors can be standard format optical fiber connectors such as LC optical fiber connectors or SC optical fiber connectors. The stub cable can include several sections including a high fiber count semi-rigid protected portion 164, a high fiber count flexible routing portion 162, a furcation/fanout device 166, and a plurality of low fiber count protected portions 168.

To make an exemplary stub cable 160 from a section of indoor riser rated 144 fiber cable containing twelve 12 fiber ribbons inside a central tube (not shown), the outer cable jacket and central tube are removed from a first end for about 60-80% of the length of the cable section to expose the loose tubes. The fiber ribbons are then inserted through a piece of flexible expandable braided tubing (¼ in. ID) without damaging any of the optical fiber within the tubes. The expandable braided tubing is slid all the way up over the cable jacket and is secured in place with a piece of 3:1 heat shrink (for example, a 4″-6″ piece) creating the high fiber count flexible routing portion 162 of the cable stub 160. When two or more stub cables are used to feed a high density optical fiber termination block, different color flexible expandable braided tubing can be used to differentiate between the stub cables.

Next, about 4 ft. of the cable jacket and central tube surrounding the twelve 12 fiber ribbons is removed from the opposite end of the cable section to expose the twelve 12 fiber ribbon. Each of the 12 fiber ribbons can be separated into individual optical fibers, each of which is fed through a color coded 900 micron loose buffer tubing contained inside an overall protective flexible jacketing. A section of the flexible jacketing of desired length is removed to expose each of the 900 micron loose buffer tubing and each optical fiber can be terminated with a SC (or LC) optical fiber connector. After this has been done to each ribbon fiber, the 12 900 μm loose buffer tubes can be placed in a protective tube that is slid up against the unstripped section of the stub cable (i.e. the high fiber count semi-rigid protected portion 164 shown in FIG. 2) and a cable furcation can be installed to secure the protective tubes. The optical fiber connectors of the stub cable can be preinstalled into the adapters in a 144-port optical fiber termination block which is then provided to the customer as an assembly. In an optical fiber termination block having 288-ports, two 144 fiber stub cables can be used or a larger (higher fiber count) starting cable can be used to create the cable stub. A lower fiber count stub cable can be prepared by an analogous process by just starting with a lower fiber count starting cable.

FIG. 1A shows a front view of exemplary high density fiber optic distribution system 100, while FIG. 1B shows a rear view of exemplary high density fiber optic distribution system. In the exemplary system, optical fibers in distribution cables from the outside plant can be connected to optical modules 150 in optical fiber termination blocks 141 via a stub cable. The optical fibers of the distribution cable are connected to the optical fibers in the stub cable in an on frame splicing compartment via optical fiber splicing technology. The optical termination modules on the frame can serve as a cross-connection field that can be interconnected by patch cords or jumper cables.

The configuration of high density fiber optic distribution system 100 enables the patch cords and jumper cables to be handled predominantly on one side of the frame (e.g. the front side of the frame), while the stub cables and the distribution cables are handled on the other side of the frame (e.g. the backside of the frame).

The distribution cables include a large number of optical fibers disposed within a cable jacket. The optical fibers can be in the form of individual 250 micron or 900 micron fibers disposed in loose tubes or as ribbon fibers disposed in loose tubes. For example, an 864 fiber distribution cable can include twelve 12 fiber ribbons disposed in six loose tubes. In addition, distribution cables can include one or more strength rods which stiffen the cable. To facilitate the routing of the optical fibers of the distribution cable, its terminal end is modified to increase its flexibility and handling. For example, when an indoor/outdoor, dry, loose tube ribbon cable construction, such as an ALTOS Ribbon all dielectric cable, 576 fiber or an ALTOS Ribbon all dielectric cable, 864 fiber available from Corning, INC. (Corning N.Y.), is used for the distribution cable, about 25 feet of cable jacket and the 6 loose tubes are removed. A piece of flexible protective furcation tubing 52 is installed over each of the 144 fiber ribbon stacks until it covers the retained loose buffer tube. The flexible furcation tube can be secured to the loose buffer tube of the distribution cable by a piece of tape. Next, a section of heatshrink tubing can be positioned over the transition region of the buffer tube and flexible furcation tubing distribution cable and shrunk in place to permanently secure the flexible furcation tubing in place creating a distribution cable furcation. This process is repeated for each buffer tube/144 fiber ribbon stack.

Referring to FIG. 1B, distribution cable 50 is secured in at least one cable bracket 95 attached on the rear side of the frame 110 around the distribution cable's cable jacket just above the cable furcation (note only one flexible furcation tubing 52 is shown in FIG. 1B for reasons of clarity).

Optical fiber termination block cable assembly 140 can be installed on a frame and the high fiber count semi-rigid protected portion 164 can be attached/clamped to the fiber termination block, for example optical fiber termination block 141a, with bracket 90 and to the frame using a bracket 92, as shown in FIG. 1B. In the exemplary embodiment shown in the figure, the space behind the patch cord routing and slack storage area 119 can provide be used to route the stub cables and the distribution cables on the frame.

A manifold bracket 96 can be attached to frame 110 and a splice compartment manifold 98 can be disposed on the splicing compartment 120 near the back of the splicing compartment. Each of the manifolds has a number of openings equal to the number of drawers in the splicing compartment. A piece of plastic tubing 80 extends from an opening in the splicing compartment manifold to a corresponding opening in the frame manifold bracket. In an exemplary aspect, a piece of plastic corrugated flexible tubing can be used. One furcation tubing 52 from the distribution cable 50 and the high fiber count flexible routing portion 162 of the cable stub 160 from each optical fiber termination block 141 is routed through the corrugated tubing to the integrated splicing compartment. Once furcation tubing 52 and flexible routing portion 162 have been fed through the plastic tubing they can enter the splicing compartment as described below.

In the exemplary embodiment, high density fiber optic distribution system 100 has one splicing compartment 120 and six optical fiber termination block cable assemblies 140, shown as optical fiber termination blocks 141a-141f in FIGS. 1A-1C. Alternatively, the exemplary system can be a modular system that having a splicing compartment and fewer than its full complement of optical fiber termination block cable assemblies initially installed. The modular nature of the optical fiber termination block cable assembly, the segregated cable management, and the on-frame splicing compartment make capacity expansion simpler than conventional distribution frames with off-frame cable splicing.

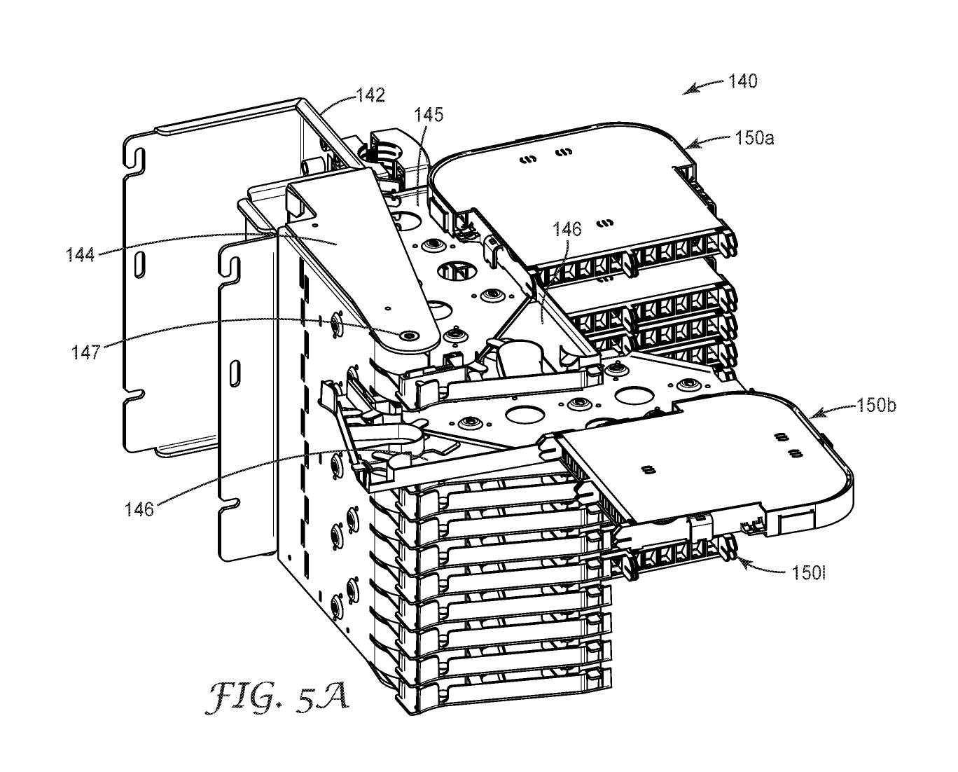

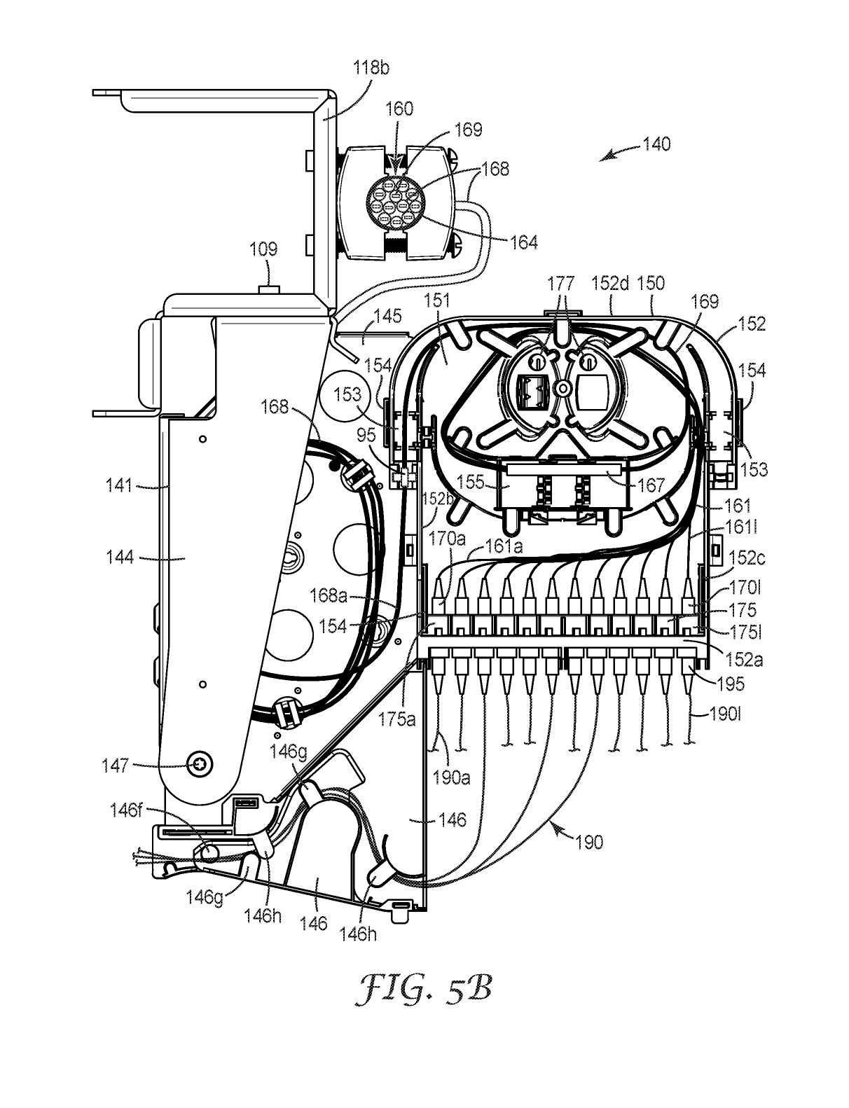

Referring to FIGS. 1A, 5A and 5B, each of the pre-terminated optical fiber termination block assemblies 140 includes a plurality of termination modules configured to connect optical fiber connectors disposed on a first end of a multi-fiber stub cable with adapter mounted in a face of each termination module. The optical fiber termination blocks that are shown in FIGS. 1A and 5A have twelve optical termination modules 150a-150l disposed on a like number of pivotal routing plates 145.

The preterminated optical fiber termination block assembly 140 is an optical fiber termination block 141 that has been preterminated with a stub cable 160. The pre-terminated optical fiber termination block according to the present invention can be attached to one of the vertical support members 118b (e.g. vertical support member 118b) of rack 110 by a mounting structure 142 and a frame-like structure 144 attached to the mounting structure that can receive a plurality of optical termination modules 150. The mounting structure can be attached to the bracket by mechanical fasteners such as by bolts 109 (FIG. 5B) or by welding the two components together.

A plurality of routing plates 145 can be pivotally attached to the frame-like structure 144 of the optical fiber termination block in order to enable individual access to the individual routing plates and the optical termination modules 150 attached thereto by rotating them from their closed position (shown in FIG. 5B) to an open position shown in in FIG. 5A. A closed position, as used herein, means a position in which the routing plate is located to some extent within the mounting structure for stowing and operating optical telecommunications elements, fiber-optic cables and/or devices, and an open position is understood to be a position in which an individual routing plate allows unhindered access thereto, for example for installation and/or maintenance. In addition, each routing plate can accommodate and store slack optical fibers and/or optical fiber ribbons entering the optical termination module attached to said routing plate.

The pivot axis 147 of the routing plate can be preferably arranged at an extremity of the routing plate 145 at a front portion of frame-like structure 144, so that the routing plate, when pivoted into an open position, gives easy access to the fibers within the optical termination module and/or on routing plate. The pivot axis of each routing plate can have any acceptable hinge structure that allows the routing plate to pivot in a direction perpendicular to the surface of the routing plate. In the figures, the pivot axis of optical fiber termination block is disposed on the left side of the optical fiber termination block 141. In an alternative embodiment, a mirror image of optical fiber termination block 141 is contemplated which has its pivot axis on the right side of the optical fiber termination block.

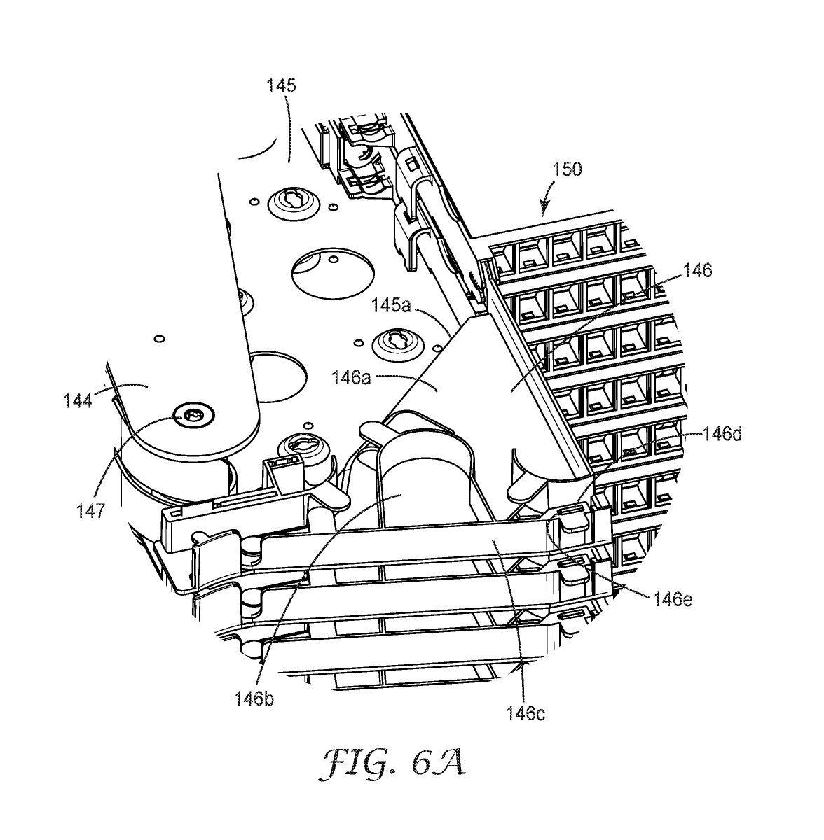

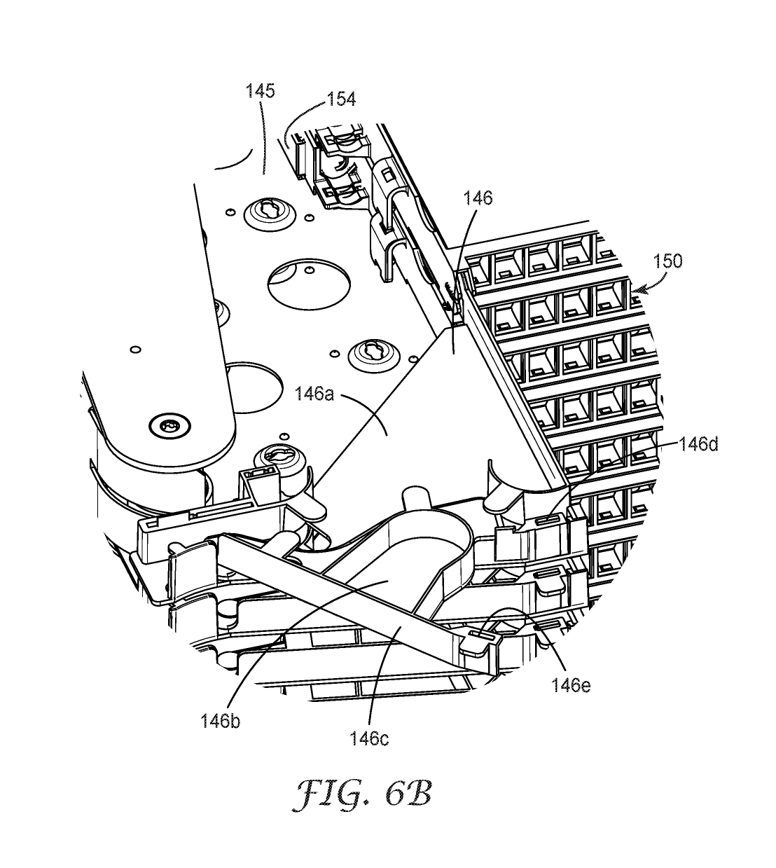

Each routing plate 145 can be preferably be adapted to guide optical fibers or optical fiber ribbons from the stub cable into the optical termination module 150 as well as storing slack of the low fiber count protected portion(s) 168 of the stub cable 150 containing the optical fibers and ribbons to be connected in the attached optical termination module. In an exemplary aspect, each routing plate can also include a jumper strain relief device 146, shown in FIGS. 5A, 5B, 6A and 6B, attached to the front edge 145a of routing plate 145.

Jumper strain relief device 146 includes a base plate 146a and a strain relief arm 146b that is rotationally attached to the base plate. The arm moves from a closed or strain relief position (FIGS. 5B and 6A) to a load or open position (FIG. 6A) to allow user to easily lay the jumper cables 190 in the jumper strain relief device. The jumper strain relief device maintains the bend radius of the jumper cables/patch cords 190 between where they are attached to the optical termination module 150 and the jumper strain relief device, as well as providing strain relief to the jumper cables to prevent disruption of the optical connection between the optical connectors 170 disposed in the optical termination module and the jumper cable connectors 195 due to accidental pulling of move/add/change (MAC) changes. In addition, the jumper strain relief device can include a labeling area 146c that can be used to support an optical terminal module identification label, port identification label or laser warning label (not shown). The strain relief arm 146b can be connected to the base plate 146a of the jumper strain relief device 146 by a bearing or rivet 146f in such a way to allow the strain relief arm to pivot with respect to the base plate. The base plate can include a tab 146d that mates with a slot 146e on the free end of the strain relief arm to secure the strain relief arm in a closed position. Alternatively, other latch designs can replace the tab and slot arrangement shown in FIG. 6A.

Advantageously, the shape of the strain relief arm 146b prevents the kinking or pinching to of the jumper cables 190 during the opening and closing of the strain relief arm or the rotating of routing plate 145 to access optical termination 150. Retention tabs 146g, 146h on the strain relief arm and the baseplate, respectively, ensure that all the jumper cables are retained in the jumper strain relief device 146 so that they do not interfere with the ability to access other optical termination modules 150 and routing plates 145. In an exemplary aspect the pathway through the jumper strain relief device is sized to accommodate the number of patch cables needed to fully connect the optical termination module. For example, the pathway through jumper strain relief device 146 shown in FIG. 5B can be sized to accommodate twelve 2 mm diameter jumper cables. If the optical termination module were outfitted with LC connectors instead of the SC connectors 170 shown in FIG. 5B, the pathway through jumper strain relief device would be able to accommodate 24 jumper cables.

This jumper strain relief device allows the rotation of the routing plates from a closed position to an open position while minimizing the tensile stress on the jumper cables to stress due to the swinging of the optical termination module out of the frame-like structure of optical fiber termination block 141, while also controlling bending radius of the jumper cables within a desired range.

Advantageously, high density fiber optic distribution system 100 also separates the many smaller, more fragile jumper cables 190 from the stub cables 160 (see FIG. 5B) as the jumpers are routed on frame 110 or from one frame to another. In contrast, jumper cables and cable stub in some conventional systems often mix in the same area causing interference and kinking of the jumper cable which can result in signal loss or degradation as well as making it harder to trace and pull out patch cables from the patch cable slack storage area 118, cable troughs 117 and raceways (not shown). The stub cables 160 of the present invention are shorter and designed to be confined to a single frame and so will not congest troughs or raceways between distribution frames. In one aspect, the cable stub is isolated to the backside of the frame while the jumper cables are isolated to the front and sides of the frame.

FIG. 5B shows a top view of an exemplary preterminated optical fiber termination block assembly 140 and the interior of an optical termination module 150. Optical termination modules 150 of the optical fiber termination block 141 enable interconnection between different signal transmitting optical fibers of the optical telecommunication network. The optical module is a tray that can be removably or permanently attached to the routing plates 145 of the optical fiber termination block. The optical module includes a tray base 151 that is substantially surrounded by tray walls 152 which are attached to the tray base along their bottom edge. The front tray wall 152a is configured to accept a plurality of connector adapters 175a-175l (collectively connector adapters 175) to accommodate the mating of optical fiber connectors 170 mounted on the terminal ends of the optical fiber of stub cable 160 with optical fiber connectors 195 on the ends of jumper cables 190a-190l (collectively referred to as jumper cables 190. The exemplary embodiment shown in FIG. 5B includes a single row of twelve SC format connector adapters175a-175l. In other embodiment, the front wall of the optical termination module can accommodate from 8-24 connector adapters across the width of the optical termination module and while optical termination module 150 includes SC format connector adapters, the same number of LC connector adapters can be used when higher connection densities are desired. In another exemplary embodiment, the optical termination can include a plurality of rows of connector adapters disposed in the front wall of the optical termination module. When there are two or more rows of connector adapters in the optical termination module, the connector adapters in one row can be disposed directly above the connector adapters in the other row(s) or the connector adapter can be staggered from one row to another row.

Tray side walls 152b, 152c extend from the ends of the front tray wall 152a toward the back of the tray where they curve toward the interior of the optical termination module and end before contacting the back tray wall 152d. The back portion of the optical termination module is somewhat wider than the front portion of the optical termination module and the back tray wall 152d extend across the back portion of the tray and part way down the sides of the tray creating the fiber access ways 153 on both sides of the optical termination module for the optical fibers to enter the optical termination module.

Optical termination module 152 can include connection means such as receptacles slots 154, hooks, slotted protrusions, latches, catches etc. that are configured to mate with corresponding features on the edge of the routing plate 145 to allow attachment of the optical termination module to the routing plate. As mentioned, the optical termination module can be removably attached to the routing plate in which case the routing plate can accommodate excess sufficient slack of the low fiber count protected portions 168 of stub cable 160 as shown in FIG. 5B to allow the optical termination module to be moved to an off frame work surface (not shown).

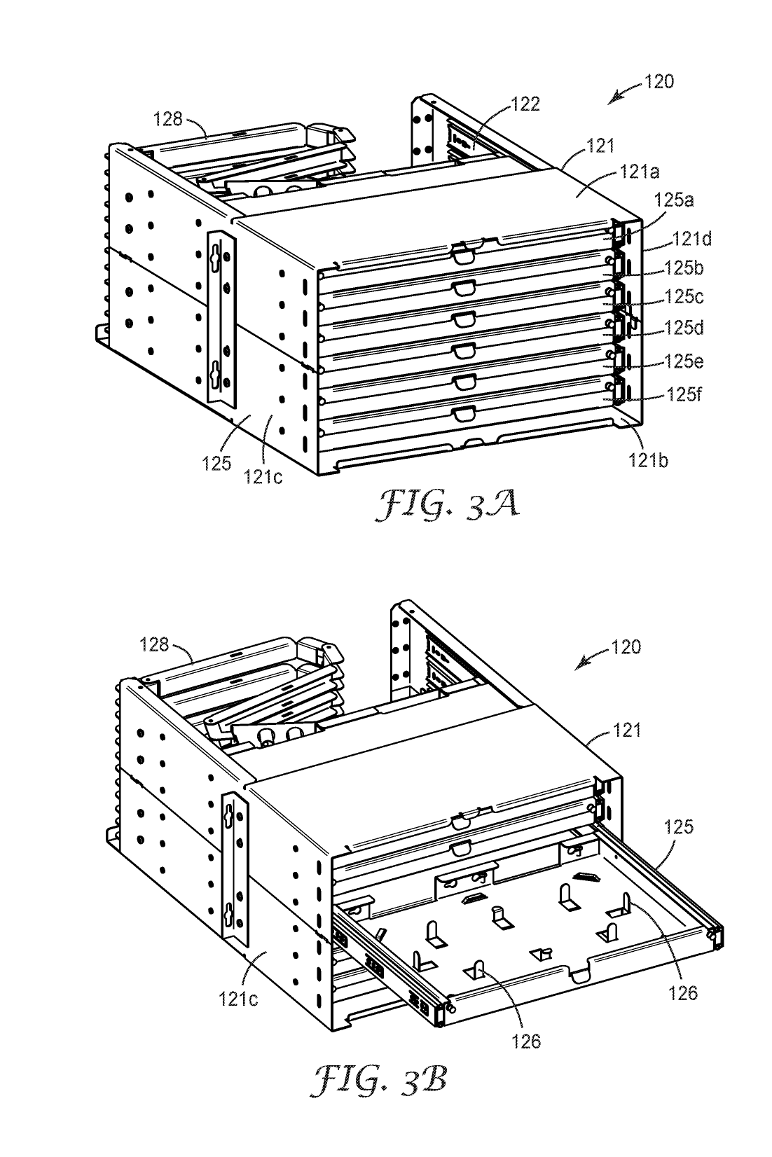

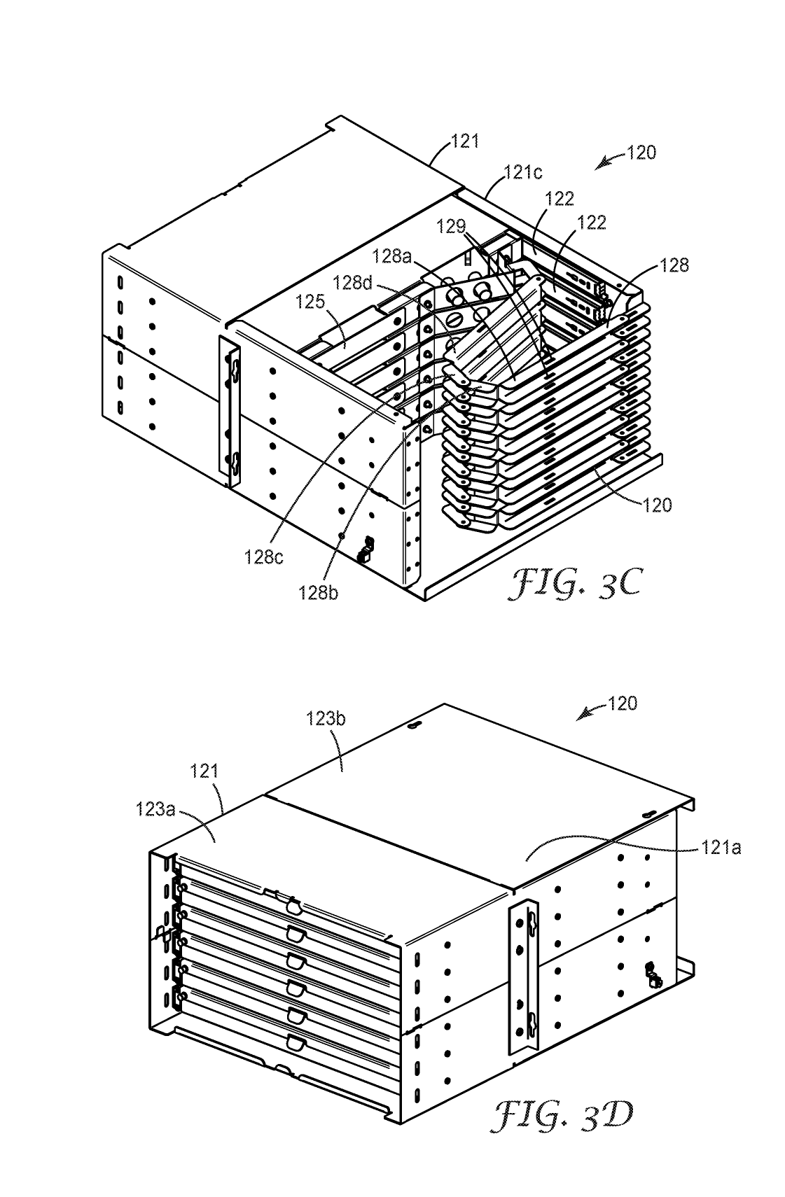

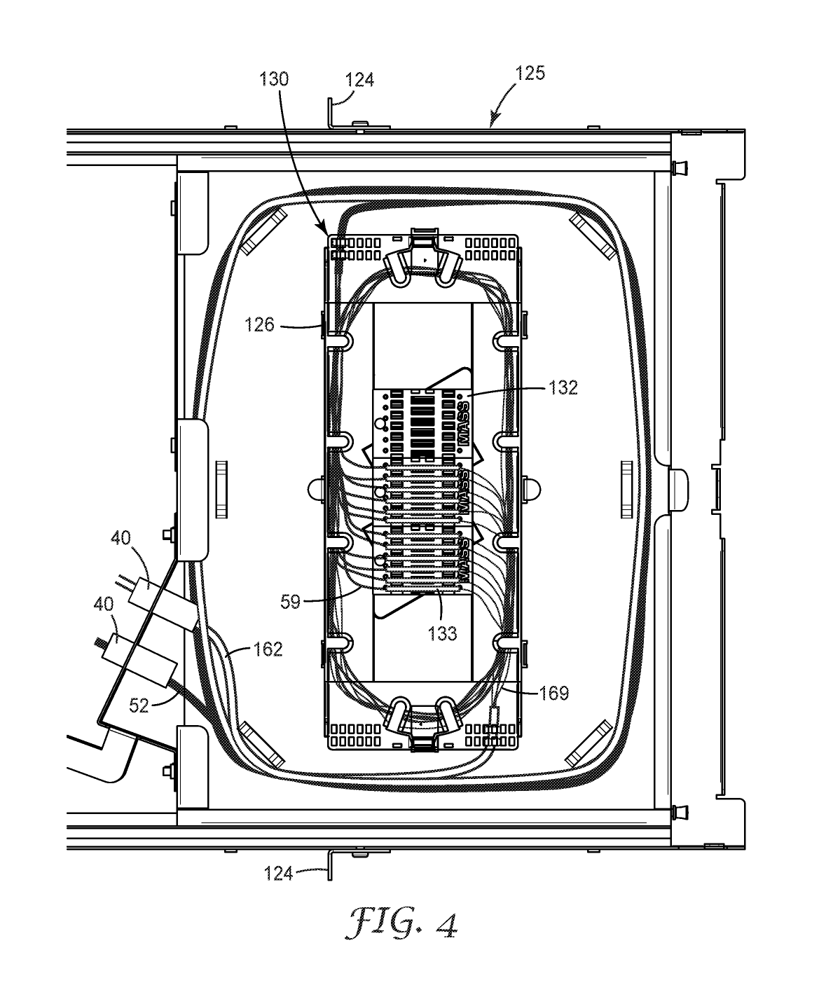

The low fiber count protected portions enters the optical termination module through the fiber access way 153 adjacent to routing plate 145. The low fiber count protected portion can be secured in the fiber access way by placing a cable tie 95 around the protective tubing of the low fiber count protected portion, as shown in FIG. 5B, and the unprotected optical fibers or optical fiber ribbon can be routed into the interior of the optical fiber termination module. In the embodiment shown in FIG. 5B, ribbon fiber 169 extends into the optical termination module 150 where the ribbon fiber can be separated into individual 250 micron fibers 161a-161l (collectively referred to as optical fibers 161) by a ribbon furcation device 167. The ribbon furcation device can be secured in a device insert 155 disposed in the optical termination module. The optical fiber connectors 170a-170l on the individual fibers are then inserted into the connector adapters 175. Any residual slack in the fiber ribbon and/or the individual fibers can be wrapped around cable management structures 177 in the slack storage portion of the optical termination module. Alternatively, the fiber ribbons can be broken out into individual fibers within furcation/fanout device 166 (FIG. 2) in stub cable 160, in which case the individual fibers enter the optical termination module through fiber access way 153. Referring to FIGS. 3A-3D and 4, splicing compartment 120 includes a plurality of splice drawers 125A-125F, collectively referred to as splice drawers 125 disposed within a housing 121. The splicing compartment can be attached to the frame of the exemplary high density distribution system by a brace 124 attached to either side of the housing of the splicing compartment. The housing can include a top wall 121a, a bottom wall 121b and two side walls 121c, 121d disposed at opposite sides of and between the top and bottom walls. A plurality of rails 122 can be attached to the inside surface of the side walls to allow the splice drawers to be slid in and out of the housing. In an exemplary aspect, the splicing compartment can be disposed at the bottom of frame 110 as shown in FIG. 1A which allows all splicing to be disposed in a single area on the frame without sacrificing connection density.

In one exemplary aspect, splicing compartment 120 can allow twelve fiber ribbon splice capacity (Fusion and/or mechanical splicing) for up to 1728 fibers without requiring a separate off-frame splice cabinet providing significant space and monetary savings to the datacenter/central office owner. Because the splicing compartment is disposed on the same frame as the optical fiber termination blocks, much shorter stub cables are needed which also eliminates the need for storing excess lengths of the stub cables.

For example, splicing compartment 120 can have six splice drawers 125A-125F that correspond to the six optical fiber termination blocks 141a-141f, wherein each splice drawer corresponds to one of the six optical fiber termination blocks. In one aspect, each drawer 125 of the splicing compartment has a splice capacity which corresponds to the connection capacity of one of the optical fiber termination block. In addition, each splice drawer can accommodate storage of excess lengths of the high fiber count flexible routing portion 162 of the stub cable from the optical fiber termination block assembly as well as excess lengths of the flexible to furcation tubing 52 containing fiber ribbons 59 from the distribution cable as shown in FIG. 4. Alternatively, each optical fiber termination block can correspond to more than one splice drawer, or each splice drawer can correspond to more than one optical fiber termination block.

Splicing compartment 120 can also include a plurality of reticulated arms 128 wherein each reticulated arm corresponds to one of the splice drawers 125 and wherein each reticulated arm serves as a fiber management channel for optical fibers and optical fiber ribbons or optical fiber cables entering the corresponding splice drawer of the splicing compartment. In an exemplary aspect, each drawer in the splicing compartment has a corresponding reticulated arm extending between the backside of the drawer to one of the side walls of the splicing compartment such as side wall 121c shown in FIG. 3C. Each of the reticulated arms is made up of a plurality of arm segments. Each arm segment 128a-128d can be pivotally attached to at least one other arm segment. The arm segments can have a U-shaped cross section having two sides, a bottom, and an open top. In some aspects, the arm segments can include cable retention features near the open top, such as a pair of slots 129 through which a cable tie can be placed or one or more tabs (not shown) that extend partially across the open top to keep the optical fibers, cables or ribbons organized and substantially within the channel formed by the arm segments sides and base. The reticulated arms extend when the splice drawers are slid out of the splicing compartment to access the interior of the splice drawers and retract when the splice drawer is closed, ensuring that the optical fibers, cables or ribbons do not become pinched or tangled.

Referring to FIG. 4, each splice drawer 125 can include at least one splice tray 130 for holding and organizing splice devices 133 in a splice insert 132 for splicing the optical fibers in fiber ribbons 59 from flexible furcation tube 52 of a distribution cable (which will be described in additional detail below) and fibers in fiber ribbons 169 from the high fiber count flexible routing portion 162 of the stub cable. The splice devices can be fusion splice devices or mechanical splice devices and can be single fiber splice devices or multi-fiber splice devices as needed for the given application. Multi-fiber ribbon fusion splices 133 are shown in splice tray 130 in FIG. 4. In one exemplary aspect, the at least one splice tray can be centrally disposed in each drawer and held in place tray positioning tabs 126. Excess length of the exposed distribution fibers or ribbons and the exposed fiber ribbons 169 or optical fibers in the stub cable can be in the slice tray so that fibers/ribbons are stored under retention tables located around the external edge of the splice tray, the excess length of the high fiber count flexible routing portion 162 of the stub cable and the excess length of the flexible furcation tubing 52 containing fiber ribbons 59 from the distribution cable can be stored in drawer 125 around the splice tray.

In one exemplary aspect, at least one of the plurality of low fiber count protected portions enter each splice drawer along a reticulated arm disposed at the backside of each of the plurality of drawers.

Referring to FIG. 1B, one or frame manifold brackets can be attached to frame 110 and a splice compartment manifold can be disposed on the splicing compartment adjacent to the end of the reticulated arm near the back of the splicing compartment. Each of the manifolds has a number of openings equal to the number of drawers in the splicing compartment. A piece of corrugated plastic tubing 80 extends from an opening in the splice compartment manifold to a corresponding opening in the frame manifold brackets. One of the furcated units from the distribution cable and the high fiber count flexible routing portion 162 of the cable stub 160 from each optical fiber termination block is routed through the corrugated tubing to the integrated splicing compartment.

Once the flexible portions from the distribution cable and the stub cable have been fed through the corrugated tubing they can be secured to the reticulated arm with cable ties or hook and loop bundling tape and fed into the appropriate splice drawer in the splicing compartment through an inlet device.

To splice the stub cable and distribution cable fibers, first remove a section of the flexible braided tubing off of each set of ribbon fibers. The exposed fiber ribbons are placed in the splice tray in the drawer and each ribbon in the cable stub is spliced to a corresponding ribbon in the distribution cable with a multi-fiber splice device.

In an exemplary aspect, the top wall 121a of the splicing compartment 120 can be composed of two wall segments 123. A permanent wall segment 123a that create an enclosed space for the drawers and a removable wall segment 123b that covers reticulated arms 128. The removable wall segment is removed during installation of the exemplary fiber distribution system described herein and can be secured in place after installation is complete to protect the optical fibers disposed in the reticulated arms from external forces that may cause signal degradation or signal loss. In addition, the reticulated arm design allows storage of a sufficient amount optical fiber to ensure that the proper fiber bend radius is maintained during opening and closing of the splice drawer without causing any signal loss due to kinking, jamming or snagging of the optical fibers/ribbons entering the drawer.

FIG. 1C shows a schematic diagram of an exemplary fiber distribution system 100 according to the present invention showing that each splice drawer 125 of the splicing compartment 120 can be correlated to one of the plurality of preterminated optical fiber termination block assemblies 140. In particular, cable stub 160a is spliced to fibers in the distribution cable in splice drawer 125a in the splicing compartment at one end and terminated in optical fiber termination block 141a at its other end. Similarly, stub cable 160b interconnects splice drawer 125b to optical fiber termination block 141b, stub cable 160c interconnects splice drawer 125c to optical fiber termination block 141c, stub cable 160d interconnects splice drawer 125d to optical fiber termination block 141d, stub cable 160e interconnects splice drawer 125e to optical fiber termination block 141e, and stub cable 160f interconnects splice drawer 125f to optical fiber termination block 141f. In this case, there is a one to one correlation between each splice drawer in the splicing compartment and each optical fiber distribution block mounted on the frame (not shown) with said splicing compartment.

Each splice drawer in the splicing compartment 120 can include a one or more splice trays to connect optical fibers in the stub cable to the optical fibers in a distribution cable. For example, FIG. 4 shows an exemplary splice drawer 125 containing one splice tray 130 which includes a plurality of splice inserts 132, each of which is configured to hold six mass fusion optical fiber slices. Thus, splice drawer 125 in FIG. 4 is configured to splice all of the fibers for a 144-288 fiber stub cable with 12 fiber ribbon mass fusion splices.

Alternatively, a plurality of optical fiber termination blocks can be correlated to a single splice drawer in the splicing compartment making a one to many correlation between each splice drawer in the splicing compartment and the optical fiber distribution blocks mounted on the frame. Alternatively in extreme high density cases or cases where the stub cable comprises a large number of discrete optical fibers, either a plurality of splice trays in a single drawer and/or a plurality of drawers may be used to splice fibers from a single optical fiber termination block.

The exemplary fiber distribution system describe herein has many advantages. The exemplary system can be used with a standard 19 in. rack/frame instead of requiring a specialized frame structure. The system can have a high connection density in a smaller footprint than many conventional systems. The system includes an integrated/built-in splicing compartment with modular drawers for each optical fiber termination block. All fiber splicing occurs in the integrated splicing compartment eliminating the need for off-frame splicing. Because all of the splicing is done in the integrated splicing compartment, shorter stub cables are needed and there is no inter-frame routing of the stub cables to be managed. This reduces the load and congestion in above rack cable raceways. The optical fiber termination block includes independent on-board jumper/patch cable strain relief for each optical termination module in the block. The system provides a modular system that allows optical fiber termination blocks to be added to the system as capacity needs increase. New optical fiber termination blocks can be added without disturbing existing service connections. Alternatively, the modularity of the exemplar system enables the use of other telecommunication on the frame/rack. The system also provides simplified integrated cable management for the distribution and stub cables on frame in separate cable management compartment on rear side of the jumper spool bay.

The built-in on rack splicing compartment of the present disclosure can save premium space in a telecommunication room rather than having to find floor space for a separate splicing cabinet. The exemplary system described herein can also reduce complexity of maintenance operations due to the very organized cabling system used and the fact that all of the interconnections between the distribution cable and the stub cable are done on the same frame where the optical termination blocks are mounted.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A fiber distribution system for interconnecting optical fibers, comprising
a frame;
a preterminated optical fiber termination block assembly mounted to the frame, wherein each of the preterminated optical fiber termination block assemblies includes a plurality of optical termination modules configured to connect optical fiber connectors disposed on a first end of a multi-fiber stub cable with connector adapters mounted in a front wall of each termination module; and
a splicing compartment mounted on the rack configure to interconnect a second end of the multi-fiber stub cable to a distribution cable, wherein the splicing compartment comprises a plurality of drawers containing optical splices and wherein each drawer of the splicing compartment can be correlated to one of the plurality of preterminated optical fiber termination blocks.

2. The system of claim 1, wherein each one of the plurality of drawers in the splicing compartment has sufficient splice capacity to interconnect all of the fibers in the multi-fiber stub cable for one of the plurality of preterminated optical fiber termination blocks to incoming fibers from the distribution cable.

3. The system of claim 1, wherein there is a one-to-one correlation between one of the plurality of drawers in the splicing compartment and the plurality of preterminated optical fiber termination block assembly mounted to the frame.

4. The system of claim 1, wherein the splicing compartment comprises a plurality of reticulated arms to route fibers of the stub cable and the distribution cable into each of the plurality of drawers.

5. The system of claim 1, wherein stub cable includes a plurality of optical fibers 161 having optical fiber connectors mounted on one end thereof.

6. The system of claim 5, wherein stub cable can be divided in several sections including a high fiber count semi-rigid protected portion, a high fiber count flexible routing portion, a furcation/fanout device, and a plurality of low fiber count protected portions.

7. The system of claim 6, wherein at least one of the plurality of low fiber count protected portions enter each splicing compartment along a reticulated arm disposed at the backside of each of the plurality of drawers.

8. The system of claim 1, wherein the splices in the splicing compartment are disposed in splice trays that are centrally disposed in each drawer.

9. The system of claim 6, wherein the splices in the splicing compartment are disposed in splice trays that are centrally disposed in each drawer and excess length of the at least one of the low fiber count protected portions is stored in the drawer around the splice tray.

10. The system of claim 1, wherein the preterminated optical fiber termination block assembly comprises a plurality of rotating plates rotatably connected to a frame like structure to provide access to the optical termination plate attached to each of the plurality of routing plates.

11. The system of claim 10, wherein each of the plurality of routing plates includes a patch cord strain relief device attached to the front edge of said routing plate to maintain bend radiuses of patch cords connected to the connector adapters mounted in a front wall of each termination module and to strain relieve the patch cords when the routing plates are rotated to access the optical termination module attached to said routing plate.

12. The system of claim 1, wherein the splicing compartment facilitates addition of one or more additional preterminated optical fiber termination block assemblies without disturbing the preterminated optical fiber termination block assembly already installed on the frame.

13. The system of claim 1, wherein the fiber distribution system segregates the multi-fiber stub cables and the distribution cable from patchcords, wherein the multi-fiber stub cables and the distribution cable are managed on a back side of the frame and the patchcords are managed on a front side of the frame.

14. The system of claim 1, further comprising a patch cord routing and slack storage area in the form of a jumper spool bay attached to the frame.
